(19) United States
(12) Patent Application Publication
(10) Pub. No.: US 2010/0328804 A1
(43) Pub. Date: Dec. 30, 2010

(54) MAGNETIC DISK STORAGE DEVICE AND METHOD CONTROLLING OF MAGNETIC DISK STORAGE DEVICE

(75) Inventors: Satoshi YAMASHITA, Yokohama-shi (JP); Kazuhiko TAKAISHI, Machida-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/821,017

(22) Filed: Jun. 22, 2010

(30) Foreign Application Priority Data
Jun. 29, 2009 (JP) 2009-154377

(51) Int. Cl. G11B 5/09

(52) U.S. Cl. 360/51; G9B/5.033

(57) ABSTRACT

According to one embodiment, a magnetic disk storage device includes a magnetic disk, a head, a clock generator, an estimating module, and a controller. The magnetic disk includes a servo area and a corresponding data area, and has a surface divided into zones in the radial direction. The basic frequency varies in the servo area depending on the zones. The head is driven to read a signal from the magnetic disk. The clock generator generates a clock signal for decoding a signal read from the data area corresponding to the servo area based on a signal read from the servo area. The estimating module estimates the position of the servo area in the radial direction, from which the head reads a signal next. The controller controls the clock generator to generate a clock signal of the basic frequency before the head reaches the servo area based on the estimated position.

### CROSS-REFERENCE TO RELATED APPLICATIONS

This application is based upon and claims the benefit of priority from Japanese Patent Application No. 2009-154377, filed Jun. 29, 2009, the entire contents of which are incorporated herein by reference.

### BACKGROUND

1. Field

One embodiment of the invention relates to a magnetic disk storage device using a magnetic disk in which the surface is divided into zones each having a different basic frequency in a servo area, and to a method of controlling the magnetic disk storage device.

2. Description of the Related Art

Recording density in magnetic disk storage devices has been increasing because of advances in, for example, higher output of replaying heads, finer recording domains of recording mediums, and the like. The magnetic disk storage device with a recording density of equal to or more than 300 gigabits per square inch has already been in practical use. In recent years, as a replacement for a storage medium that employs a conventional continuous recording film, it has been proposed to use a discrete track medium the recording density of which is increased by the addition of side-erase resistance in which non-magnetic grooves are provided on a magnetic disk to prevent replaying signal degradation caused by writing to adjacent tracks.

For this discrete track medium, it is often the case that a servo pattern is formed in a servo area by patterning at the time of manufacturing the medium during. Japanese Patent Application Publication (KOKAI) No. 2007-12118 discloses a method of manufacturing a discrete track medium.

A disk that employs a conventional continuous recording film performs magnetic recording of a servo pattern by, as with writing to a data area, energizing a recording coil of a flying head by a servo writer. On the other hand, the discrete track medium is formed by manufacturing a master by an electron beam lithography system and processing the master by a nanoimprint method or the like. Because of this, degradation factors that occur in various processes conspire, and thus it is difficult to improve the servo quality. Therefore, it is difficult for the discrete track medium to simply have the same recording density as compared with a disk that employs the conventional continuous recording film on which the servo pattern is recorded by magnetic recording.

The magnetic disk storage device is required to have fast access. For this reason, servo signals are decodable in a signal detection circuit in the same condition, with the basic frequency in the servo area being constant in the radial direction of the disk, to allow the position-feedback control of the recording and replying head wherever on the disk the head is located.

With the discrete track medium, when the basic frequency in the servo area is determined based on the recording density which ensures the servo quality at the innermost periphery, the recording density decreases as compared with that of the continuous recording film, and the ratio of the servo area to the data area per disk increases. Therefore, it is difficult to increase the capacity of the discrete track medium as a recording medium.

A magnetic disk storage device has been developed, in which the top of the disk is divided into a plurality of zones in a radial direction, and each of the zones has a different basic frequency in a servo area. This solves the disadvantages of the discrete track medium described above. Japanese Patent Application Publication (KOKAI) No. H10-255416 discloses a conventional technology in which the basic frequency in a servo area is set to be lower for an inner peripheral zone than for an outer peripheral zone to switch a sequencer according to a zone sought by a magnetic disk head.

The conventional technology is on the condition that there is no change in timing and the frequency of the sequencer during a seek. Further, according to the conventional technology, a preamble in a servo area is not used for the entrainment of a clock frequency performed by a phase locked loop (PLL) when a different zone is sought. Therefore, a decoding error may occur when a different zone is sought.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a magnetic disk storage device according to an embodiment of the invention;

FIG. 2 is an exemplary schematic diagram of a magnetic disk in the embodiment;

FIG. 3 is an exemplary chart of a servo basic frequency shift relative to the radial position of the magnetic disk in the embodiment;

FIG. 4 is an exemplary chart of a servo basic frequency shift relative to the radial position of the magnetic disk in the embodiment;

FIG. 5 is an exemplary chart of a servo basic frequency shift relative to the radial position of the magnetic disk in the embodiment;

FIG. 6 is an exemplary chart of a servo basic frequency shift relative to the radial position of the magnetic disk in the embodiment;

FIG. 7 is an exemplary diagram of a servo pattern in the embodiment;

FIG. 8 is an exemplary diagram of another servo pattern in the embodiment;

FIG. 9 is an exemplary block diagram of a decoder in the embodiment;

FIG. 10 is an exemplary flowchart of a seek operation in the embodiment;

FIG. 11 is an exemplary timing chart for explaining the seek operation in the embodiment; and

FIG. 12 is an exemplary timing chart for explaining an operation when a magnetic head unexpectedly crosses a zone boundary in the embodiment.

### DETAILED DESCRIPTION

Various embodiments according to the invention will be described hereinafter with reference to the accompanying drawings. In general, according to one embodiment of the invention, a magnetic disk storage device comprises a magnetic disk, a head, a clock generator, an estimating module, and a controller. The magnetic disk comprises a servo area and a data area corresponding to the servo area on each track. The magnetic disk is configured to have a surface divided into zones in the radial direction of the magnetic disk. The basic frequency varies in the servo area depending on the zones. The head is configured to be driven in the radial direction and read a signal from the magnetic disk. The clock generator is configured to generate a clock signal for decoding a signal read by the head from the data area corresponding to the servo area based on a signal read by the head from the servo area. The estimating module is configured to estimate the position of the servo area in the radial direction, from which the head reads a signal next, when the head is driven in the radial direction. The controller is configured to control the clock generator to generate a clock signal of the basic frequency corresponding to the servo area from which the head reads a signal next before the head reaches the servo area based on the position estimated by the estimating module.

According to another embodiment of the invention, there is provided a method of controlling a magnetic disk storage device that comprises a head driven in the radial direction of a magnetic disk to read a signal from the magnetic disk provided with a servo area and a data area corresponding to the servo area on each track and having a surface divided into zones in the radial direction. The basic frequency varies in the servo area depending on the zones. The method comprises: a clock generator generating a clock signal for decoding a signal read by the head from the data area corresponding to the servo area based on a signal read by the head from the servo area; an estimating module estimating a position of the servo area in the radial direction, from which the head reads a signal next, when the head is driven in the radial direction; and a controller controlling the clock generator to generate a clock signal of the basic frequency corresponding to the servo area from which the head reads a signal next before the head reaches the servo area based on the position estimated by the estimating module.

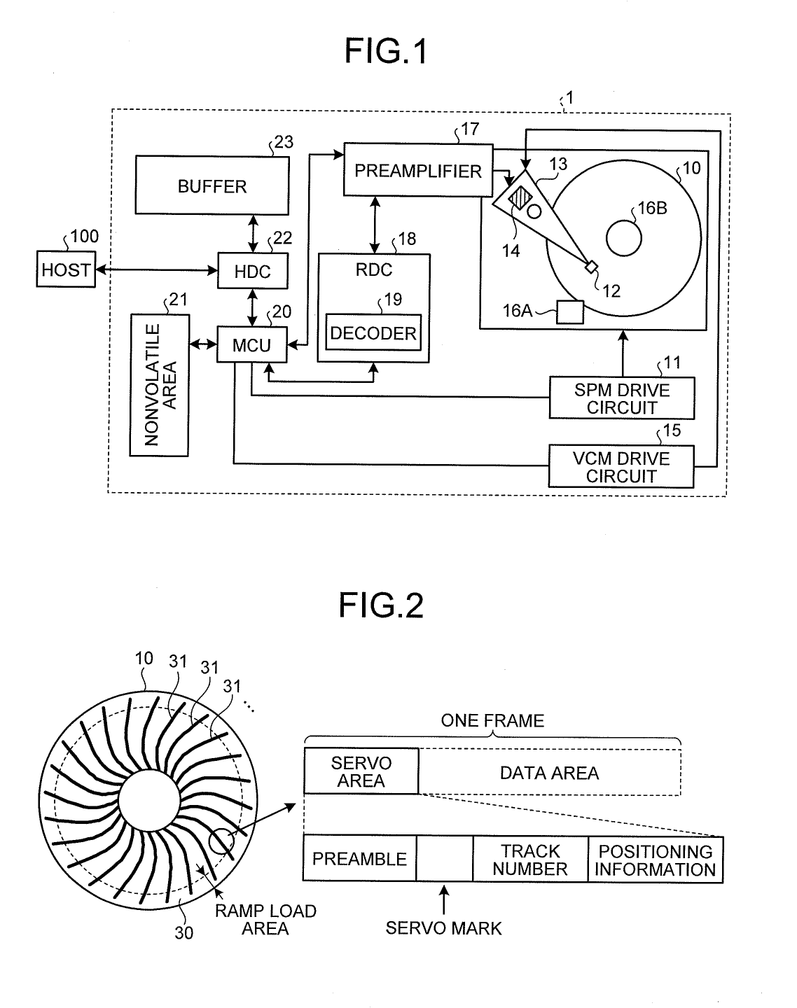

FIG. 1 illustrates an example of a configuration of a magnetic disk storage device 1 according to an embodiment of the invention. The magnetic disk storage device 1 performs, as with a conventional magnetic disk storage device, drive control of a magnetic head by forming a feedback loop at all times during track following and during a seek.

In FIG. 1, a spindle motor (not illustrated) rotates a magnetic disk 10 about a rotation axis as the center at a predetermined rotation speed. A spindle motor (SPM) drive circuit 11 drives the rotation of the spindle motor. As described in detail later, a servo area on which servo information comprising position information on the disk is recorded, is arranged in the magnetic disk 10.

A magnetic head 12 comprises a recording head and a replaying head, and performs writing and reading signals on and from the magnetic disk 10. The magnetic head 12 is attached to the end of a head actuator 13, and is moved in a radial direction of the magnetic disk 10 by a voice coil motor (VCM) 14 driven by a VCM drive circuit 15. An outer stopper 16A and an inner stopper 16B are both provided to restrict the rotation range of the head actuator 13.

A preamplifier 17 amplifies a signal read out from the magnetic disk 10 by the magnetic head 12 and outputs the signal, and then supplies it to a read write channel (RDC) 18. The preamplifier 17 also amplifies a signal for writing to the magnetic disk 10, supplied form the RDC 18, to supply the signal to the magnetic head 12.

The RDC 18 modulates the code of digital data for writing to the magnetic disk 10, supplied form a micro control unit (MCU) 20 described later, to supply the data to the preamplifier 17. The RDC 18 also decodes the code of a signal that is read out from the magnetic disk 10 and is supplied from the preamplifier 17, at a decoder 19 to output the signal as digital data. In this process, the decoder 19 generates a clock through a phase locked loop (PLL) circuit based on a signal read out from the servo area provided on the magnetic disk 10, and replays the digital data using this clock.

The MCU 20 comprises, for example, a microprocessor, a random access memory (RAM), and a read only memory (ROM). The MCU 20 reads a computer program stored in a nonvolatile area 21 in advance as needed to perform the overall control of the magnetic disk storage device 1, according to firmware stored in the ROM in advance.

A hard disk controller (HDC) 22 performs: the control of the transmission and reception of data that is performed between a host computer 100 and the magnetic disk storage device 1 through a host interface (I/F) (not illustrated); the control of a buffer and a cache; the correction process of data error on recording data; a servo control; and the like. The HDC 22 comprises a shock sensor that detects impact, vibration, and the like, applied on the magnetic disk storage device 1. A buffer 23 is used for the buffering of data transmitted and receipted between the host computer 100 and the magnetic disk storage device 1, and for other applications.

FIG. 2 is a schematic diagram of the magnetic disk 10 of the embodiment. In the example of FIG. 2, a ramp load area 30 is provided at the outer peripheral side of the magnetic disk 10 to evacuate the magnetic head 12 by using a ramp mechanism 16. In addition, a servo area on which information used to perform the positioning control that positions the magnetic head 12 against the magnetic disk 10 is recorded, is arranged. In the example of FIG. 2, the same number of servo areas are recorded on each track, and thus patterns 31, 31, and so on that extend from the rotation center in a radial direction in an arc shape, are formed.

As illustrated on the right side of FIG. 2, one frame is constituted with one servo area and a data area that follows the servo area. The servo area in one frame comprises a preamble, a servo mark, a track number, and positioning information. The preamble is an area for drawing in a servo basic frequency through the PLL. The data in the data area is decoded using a clock generated in the PLL based on a signal read out from the preamble. The servo mark is represented by, for example, double digit hex number, and is identification information identifying that the frame is a frame of the servo information. The track number is recorded in a Gray code. The positioning information is represented as relative position information of the magnetic head 12 against tracks by a burst signal.

In the embodiment, as the magnetic disk 10 illustrated in FIG. 2, a medium in which the number of servo areas on the tracks arranged from inner peripheral to outer peripheral is constant, and that is divided into zones having at least two basic frequencies in the servo areas, is used. The basic frequencies in the servo areas are set based on the frequency in the outermost peripheral zone so that the frequency decreases towards the innermost peripheral zone in each zone in order. In other wards, the recording density on the magnetic disk 10 is set to gently increase from the outer peripheral side to the inner peripheral side.

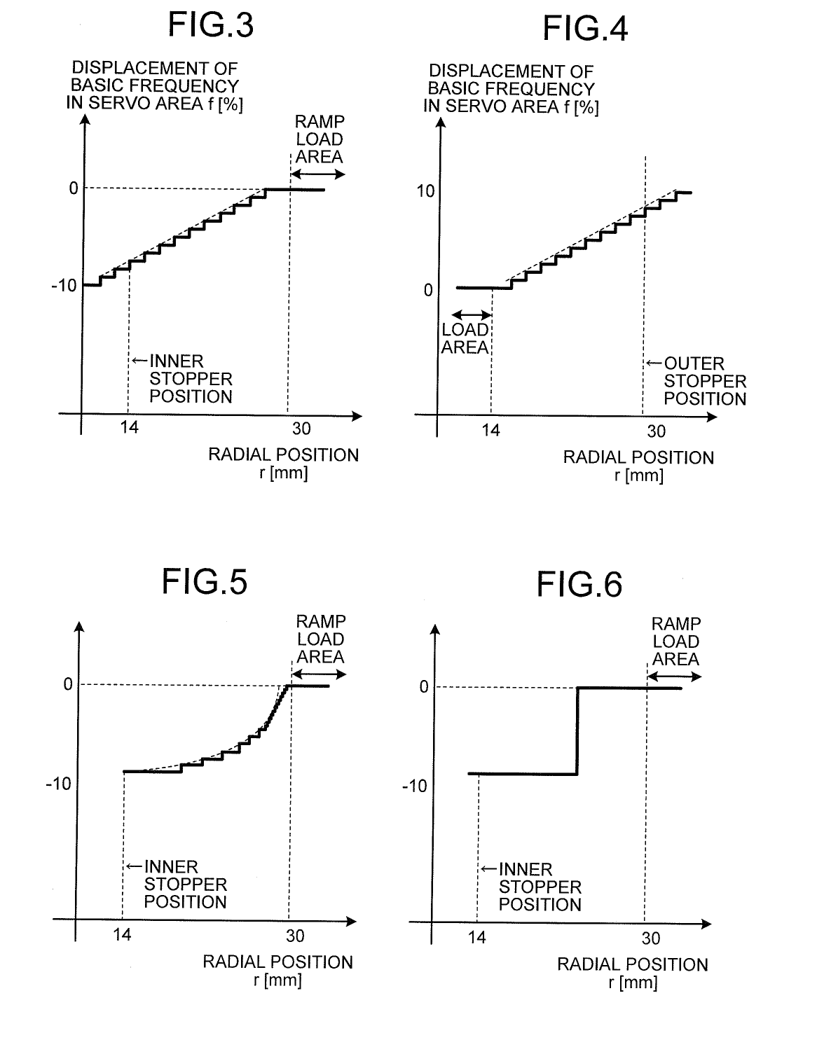

FIGS. 3 to 6 illustrate examples of a basic frequency shift in a servo area relative to the radial position of the magnetic disk 10. The radial position at which the basic frequency in the servo area is displaced is a zone boundary. FIG. 3 illustrates an example when the evacuation position for the magnetic head 12 is provided in the ramp load area 30 at the outer periphery of the magnetic disk 10. In this example, an area where the basic frequency in the servo area is constant is provided at the outer peripheral side of the magnetic disk 10 that comprises the ramp load area 30. In the example of FIG. 3, based on the frequency in this area, the servo area is formed so that the basic frequency in the servo area is gradually displaced to a lower frequency, from the outer peripheral side to the inner peripheral side of the magnetic disk 10.

In contrast, FIG. 4 illustrates an example when the evacuation position for the magnetic head 12 is provided in a load area at the inner peripheral side of the magnetic disk 10. In this example, an area where the basic frequency in the servo area is constant, is provided at the inner peripheral side of the magnetic disk 10. In the example of FIG. 4, based on the frequency in this area, the servo area is formed so that the basic frequency in the servo area is gradually displaced to a higher frequency, from the inner peripheral side to the outer peripheral side of the magnetic disk 10.

In the examples of FIGS. 3 and 4, the basic frequency in the servo area is rectilinearly displaced relative to the radial position of the magnetic disk 10, but which is not limited to the examples. For example, as illustrated in FIG. 5, the basic frequency in the servo area may be curvedly displaced relative to the radial position of the magnetic disk 10. FIG. 6 illustrates an example when the basic frequency in the servo area is displaced at only one position relative to the radial position of the magnetic disk 10, and the number of divided zones is the minimum of two.

When the magnetic disk storage device 1 comprises a plurality of the magnetic disks 10, 10, and so on, a different dividing method of zones in the servo areas may be used on each of the magnetic disks 10, 10, and so on. As a matter of course, the same dividing method of zones in the servo areas may be used on the magnetic disks 10, 10, and so on. The magnetic disk 10 is not limited to a discrete track medium, and a continuous recording medium may also be used as the magnetic disk 10.

With such a configuration, after turning the power on, the MCU 20 reads a computer program stored in the nonvolatile area 21 by firmware as needed to run the program, and controls the SPM drive circuit 11 to rotate the spindle motor. When the rotation of the spindle motor reaches a steady rotation speed, the MCU 20 controls the VCM drive circuit 15 to drive the head actuator 13 by the VCM 14, and moves the magnetic head 12 at a constant speed from the ramp load area 30 that serves as the evacuation position for the magnetic head 12 to the magnetic disk 10, to load the magnetic head 12 thereon.

While the magnetic head 12 is loaded, the MCU 20 searches in the servo areas on the magnetic disk 10 in an attempt to detect the servo marks. When the servo marks can be detected successively, the MCU 20 shifts to a seek control mode in which the magnetic head 12 is moved to a track on the magnetic disk 10 that comprises a system area, based on position information obtained by decoding the servo areas.

Calibration information and the like of each of the magnetic head 12 and the magnetic disk 10 are recorded in the system area. When the magnetic head 12 reaches the track that comprises the system area, the MCU 20 reads recorded information recorded in the track from the magnetic disk 10 to develop calibration data and the like of each of the magnetic head 12 and the magnetic disk 10 to the buffer 23. Subsequently, the magnetic disk storage device 1 goes into a full operation. As an example, the MCU 20 performs position control or the like of the magnetic head 12 in response to the command issued from the host computer 100.

For example, information related to zone division of the servo areas is stored in the nonvolatile area 21 in advance. More specifically, a table that indicates a relationship between the radial position of the magnetic disk 10, i.e., a track number, and the amount of the basic frequency shift in the servo area is stored in the system area of the magnetic disk 10 in advance. Examples are not limited to this, the table maybe stored in the nonvolatile area 21, the ROM in the MCU 20, or the like in advance. As more specific example, the table stores a relationship between the radial position and the amount of the basic frequency shift in the servo area, as illustrated in FIGS. 3 to 6.

During a seek process, the MCU 20 determines the displace amount of the basic frequency in the servo area referring to the table, prior to reading the servo area at a target position for a seek. Subsequently, the MCU 20 performs feedforward control in a servo area unit on the PLL circuit of the decoder 19 to change the clock frequency output from the PLL circuit into a frequency depending on the shift amount obtained by referring to the table.

In the embodiment, just before the servo area at a target position is read, the clock frequency to be used for decoding a signal is set to the basic frequency in the servo area at the target position in advance by performing feedforward control on the PLL circuit of the decoder 19. As a result of this, wherever the magnetic head 12 moves on the magnetic disk 10 by a seek operation, servo decoding can be easily performed.

In practice, even when the servo decoding becomes temporarily impossible because of a defect in the magnetic disk 10 or the like, error does not occur immediately. In addition, the servo decoding can be easily performed even at a zone boundary portion.

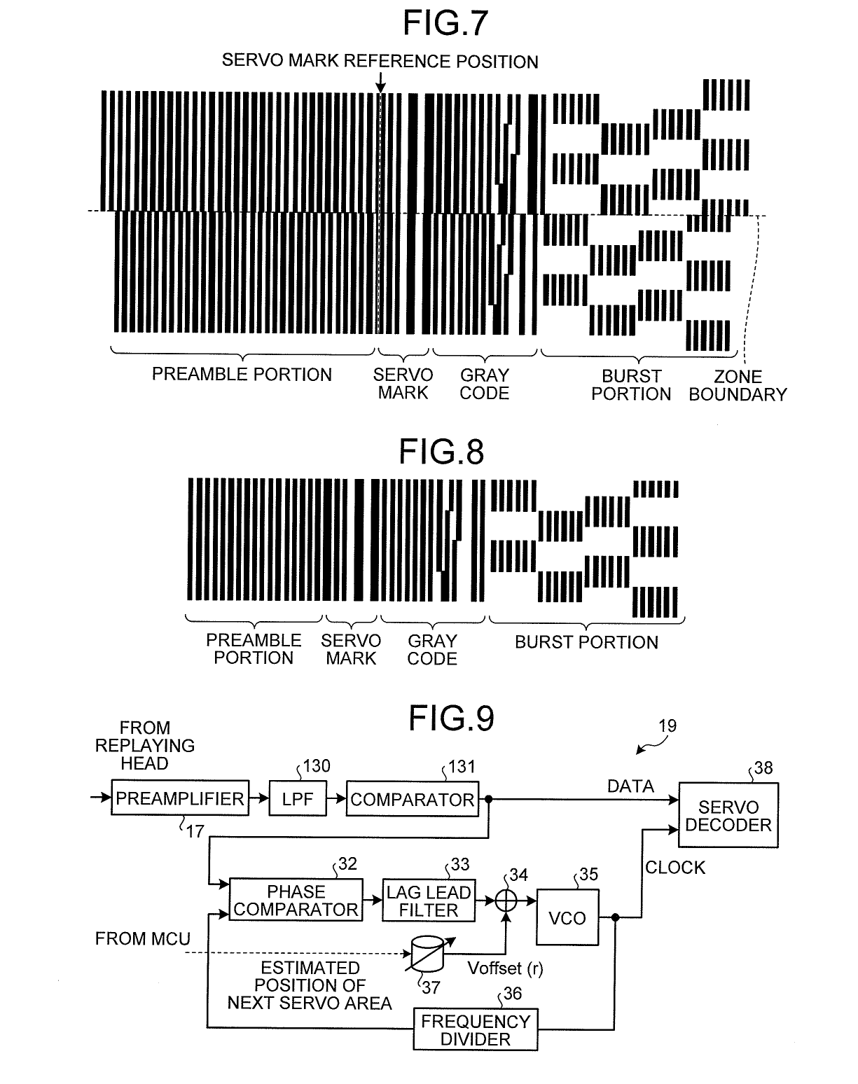

FIGS. 7 and 8 are more specific examples of a servo pattern in the embodiment. FIG. 7 illustrates an example of a servo pattern in a servo area arranged in a zone boundary portion. At the zone boundary, the length of a preamble is lengthened so that when the magnetic head 12 moves with crossing the zone, clock generation is easily performed in the PLL. On the other hand, at the inside of the zone, as illustrated in FIG. 8, the preamble is shortened to improve a recording density.

FIG. 9 illustrates an example of a configuration of the decoder 19 in the embodiment. As can be seen from FIG. 9, the decoder 19 comprises a PLL circuit. A replaying signal read out from the magnetic disk 10 using a replaying head in the magnetic head 12 is supplied to the decoder 19 inside of the RDC 18 through the preamplifier 17. The replaying signal is binarized by: being integrated by a low pass filter (LPF) 130; and being compared with a predetermined voltage by a comparator 131. The output of the comparator 131 is supplied to a servo decoder 38 as modulated data as well as is received at one input end of a phase comparator 32. The output of a frequency divider 36 described later is received at the other end of the phase comparator 32.

The phase comparator 32 compares the phases of signals received at the one and the other input ends. A phase difference signal obtained from the comparison result is integrated by a lag lead filter 33 to be a voltage value, and is supplied to a voltage controlled oscillator (VCO) 35 through an adder 34. The VCO 35 outputs a signal having a frequency depending on the voltage value supplied. This signal is supplied to the frequency divider 36 as well as supplied to the servo decoder 38 as a clock signal. The frequency divider 36 frequency-divides the signal supplied from the VCO 35 at a predetermined frequency dividing ratio to enter the signal to the other input end of the phase comparator 32.

The servo decoder 38 decodes modulated data supplied from the comparator 131 by a predetermined decoding method, for example, Viterbi decoding, based on the clock signal supplied from the VCO 35 to output the data as digital data.

Although the illustration is omitted, the operation performed by the servo decoder 38 is controlled by a servo gate (SG) signal indicating that either one of signals read out from the servo area or the data area is the signal read out by the magnetic head 12. The SG signal is generated by, for example, the HDC 22, and indicates that in a high state, the signal read out by the magnetic head 12 is a signal in the servo area. The servo decoder 38 decodes the signal in the servo area during the period in which the SG signal indicates the servo area.

In the embodiment, the MCU 20 estimates the position of the servo area to be read the next. For example, the MCU 20 estimates the servo area to which the magnetic head 12 is moved next, based on a target position indicated by address information contained in a write command or a read command (hereinafter, the commands are collectively called a W/R command) transmitted from the host computer 100. The MCU 20 refers the table that indicates the relationship between a track number and the amount of the basic frequency shift in the servo area as described above to determine the estimated amount of the basic frequency shift in the servo area.

The information that indicates this shift amount is supplied from the MCU 20 to the decoder 19 and is received in an offset voltage adding module 37. The offset voltage adding module 37 outputs an offset voltage Voffset (r) for changing the oscillation frequency of the VCO 35 by the shift amount, based on the information that indicates this shift amount received. The offset voltage Voffset (r) is supplied to the adder 34.

The adder 34 adds the offset voltage Voffset (r) to the voltage value output from the lag lead filter 33 to supply the resultant value to the VCO 35. Accordingly, the VCO 35 can output a clock signal having a frequency corresponding to the estimated basic frequency in the servo area. Thus, the servo decoder 38 can promptly decode modulated data in the servo area, which enables high-speed access. As a result of this, an appropriate basic frequency in the servo area can be set on each zone formed by dividing the magnetic disk 10 into zones, and the recording density of the magnetic disk 10 can be increased.

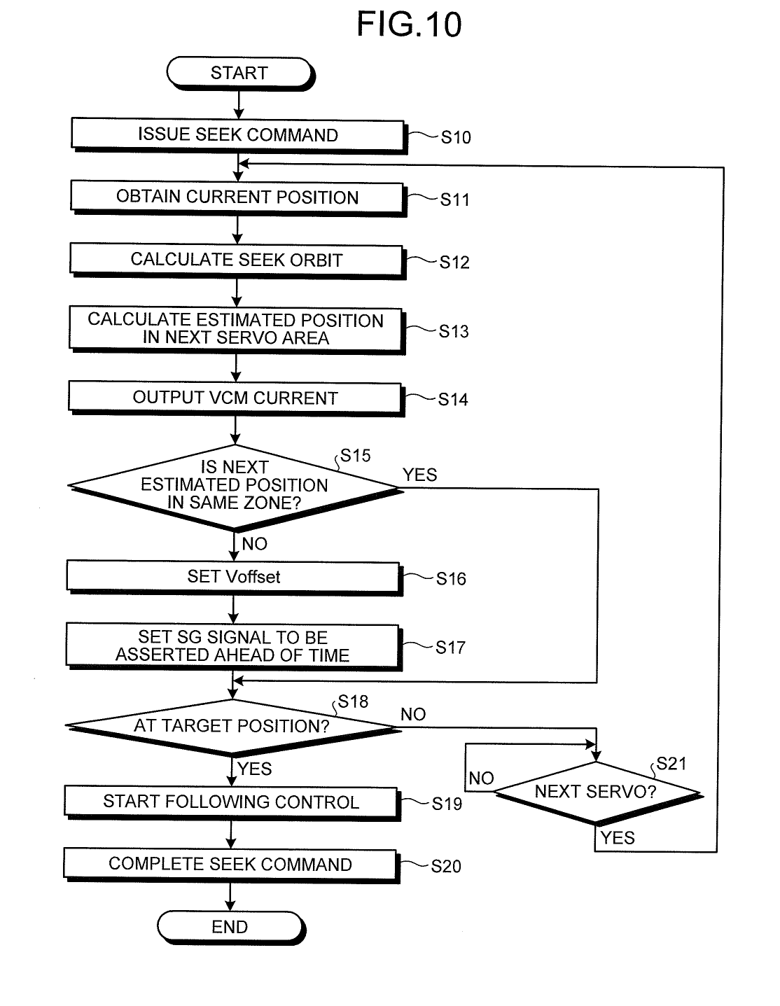

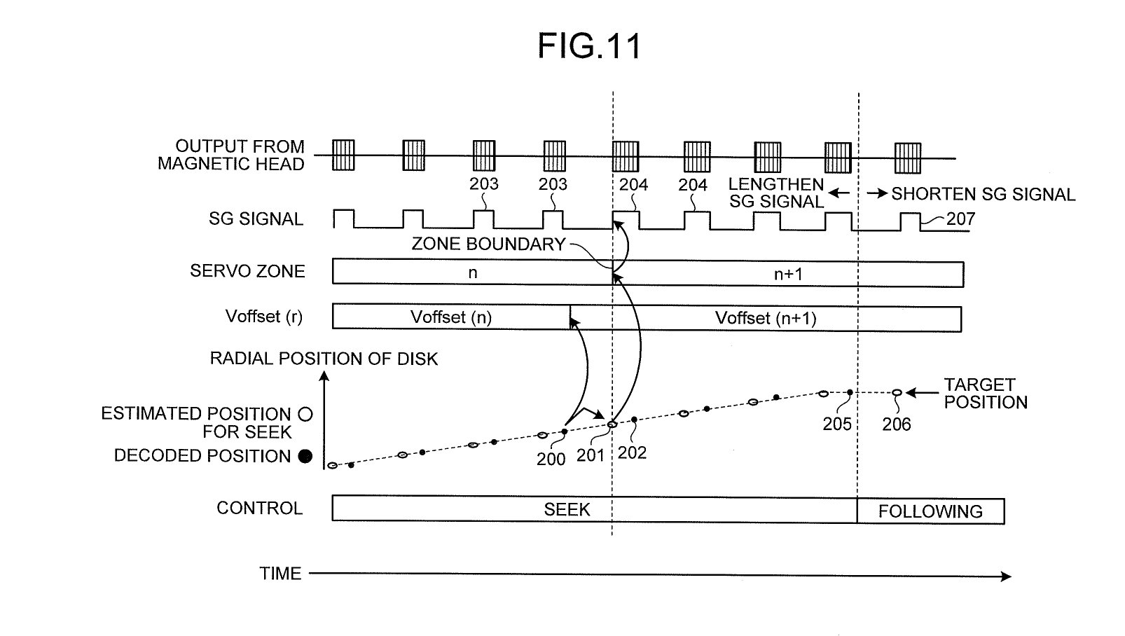

An example of a seek operation in the embodiment will be described referring to FIGS. 10 and 11. For example, the W/R command is issued from the host computer 100 to the magnetic disk storage device 1. The W/R command is supplied to the MCU 20 through the HDC 22. The MCU 20 issues, based on address information contained in the W/R command, a seek command for moving the magnetic head 12 to a track at a target position indicated by the address information (S10).

The MCU 20 obtains the current position of the magnetic head 12, based on data that is a signal read out from the servo area by the magnetic head 12 and decoded by the decoder 19 (S11). At S12, the MCU 20 calculates the trajectory of the magnetic head 12 to be obtained by a seek operation, from the relationship between the current position of the magnetic head 12 obtained at S11 and the target position indicated by the W/R command. The MCU 20 starts the seek operation performed by the magnetic head 12 by controlling the VCM drive circuit 15 following the calculated seek trajectory.

The MCU 20 calculates an estimated position in which the position of the following servo area is estimated, on each servo area, until the magnetic head 12 reaches the target position to complete the seek operation (S13). For example, the MCU 20 determines the radial position of the magnetic disk 10 when the magnetic head 12 reaches the following servo area, based on a known seek speed and the rotation speed of the magnetic disk 10. More specifically, the MCU 20 calculates the radial position of the magnetic disk 10 in the servo area where the magnetic head 12 is estimated to reach immediately after the current position of the magnetic head 12, that is, a decoded position.

In the example of FIG. 11, black circles () and white circles (∘) denote decoded positions and estimated positions, respectively. The decoded position is indicated by, for example, the end of the Gray code, and the estimated position is indicated by, for example, the beginning of the servo area.

Subsequently, the MCU 20 outputs current for driving the VCM 14 by controlling the VCM drive circuit 15 to make the magnetic head 12 seek (S14).

At S15, the MCU 20 refers the table for the amount of the basic frequency shift in the servo area as described above to determine whether the estimated position calculated at S13 and a current position are in a same zone. If the estimated position and the current position are determined to be in the same zone, the process moves to S18 described later, and whether the magnetic head 12 reaches the target position is determined.

On the other hand, at S15, if the estimated position and the current position are determined to be in a different zone, the process moves to S16, and the MCU 20 sets an offset voltage Voffset (r). For example, in FIG. 11, an estimated position 201 estimated from a decoded position 200 as a current position, is on a zone boundary. The decoded position is, for example, at the end of the Gray code. Therefore, the decoded position corresponding to the estimated position 201 is a position 202 that proceeds from the estimated position 201 in a seek direction, and that crosses the zone boundary. In the example of FIG. 11, while the decoded position 200 as a current position is in a zone n, the decoded position 202 corresponding to the estimated position 201 is in a next zone n+1.

At S16, the MCU 20 adds an offset voltage Voffset (r) to the voltage to be supplied to the VCO 35, to output a signal of the basic frequency in a servo area at the estimated position, by controlling the offset voltage adding module 37 in the decoder 19.

As an example, in the example of FIG. 11, the MCU 20 refers the table for the amount of the basic frequency shift in the servo area as described above to calculate difference between a shift amount at the current position and a shift amount at the estimated position, based on a track number obtained by decoding the Gray code in the servo area. The MCU 20 sets an offset voltage Voffset (r) by which the frequency of the signal generated by the VCO 35 is changed depending on the difference of the calculated shift amount.

Information that indicates the set offset voltage Voffset (r) is supplied from the MCU 20 to the offset voltage adding module 37, and the offset voltage Voffset (r) is output from the offset voltage adding module 37. The offset voltage Voffset (r) is supplied to the adder 34 and added to the voltage output from the lag lead filter 33 to be supplied to the VCO 35.

At S17, the MCU 20 makes timing for asserting an SG signal for operating the servo decoder 38 be effected faster by controlling the HDC 22 to displace the timing forward, and sets the period for asserting the SG signal to be long. In the example of FIG. 11, SG signals 204, 204, and so on at the estimated position 201 and at the following position are set to be longer than SG signals 203, 203, and so on at just before the decoded position 200 with which the estimated position 201 corresponding to the decoded position that crosses the zone boundary is calculated. Because of this, the preamble in the servo area can be used for a longer period as compared with the preamble when a seek is performed in the same zone, which eases the drawing-in by the PLL.

When the following control described later is started, the SG signal is reset to its former length and timing, as exemplified as an SG signal 207 in FIG. 11.

In this process, when the estimated position crosses over the zone, but the actual seek position does not cross the zone, the system temporarily gets in a state where the decoding of the servo area cannot be performed. However, the seek position is expected to cross the zone in the following servo areas, and therefore the decoding can be restarted without special processes, and a decoding error in a several servo area can be ignored.

When the SG signals are displaced at S17, the process moves to S18 to determine whether the magnetic head 12 reaches the target position. If the magnetic head 12 is determined not to reach the position, the process moves to S21, and is waited until the magnetic head 12 reads the signal in the next servo area. When the magnetic head 12 reads the signal in the next servo area, the process returns to S11.

On the other hand, if the magnetic head 12 is determined to reach the target position at S18, the process moves to S19, and the following control is started. In the example of FIG. 11, the following control is started after a decoded position 205, because an estimated position 206 estimated from the decoded position 205 reaches the target position. When the establishment condition for the following control is satisfied, a seek command is completed (S20).

The use of areas near the zone boundary of servo areas as data areas is desirably avoided, because zones during writing and during reading are different. This avoidance is called a track slip process. The number of tracks to be slipped is changed corresponding to the read element, the write element, and a yaw angle of the magnetic head 12. The track slip information is for example, stored in the system area of the magnetic disk 10 in advance, and developed to the buffer 23 every time the magnetic disk storage device 1 is started.

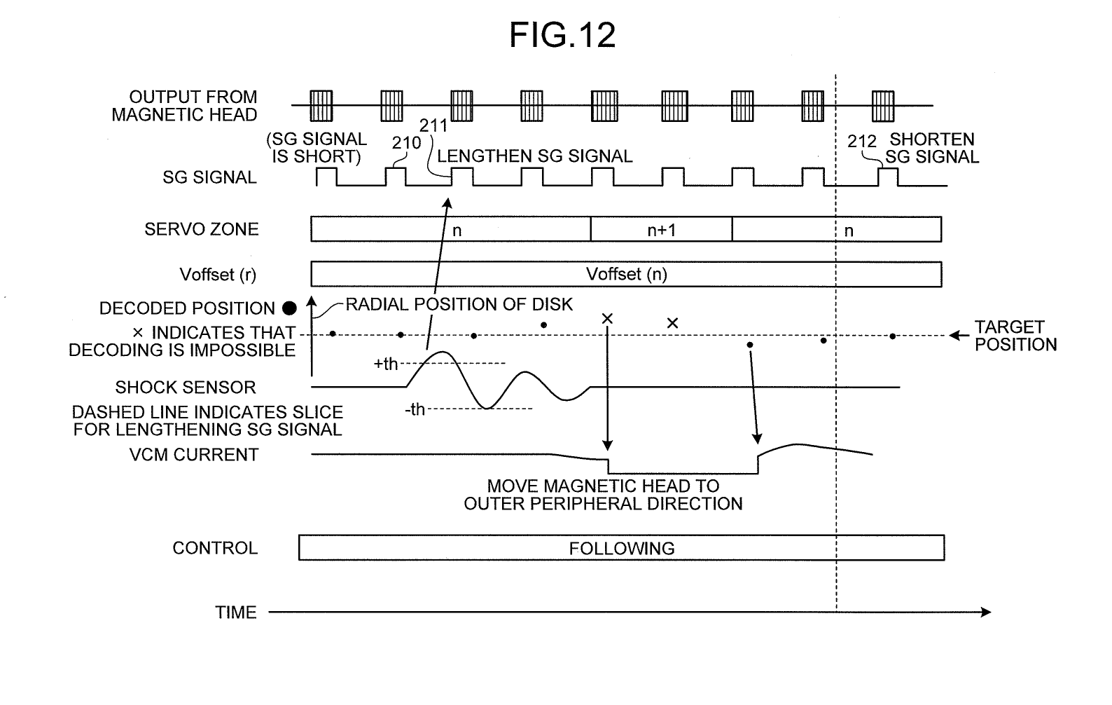

Generally, the following control is not often performed in the zone boundary. However, impact or vibration may be applied on the magnetic disk storage device 1 during the following control, which may unexpectedly make the magnetic head 12 cross the zone boundary. An example of the operation in this case is explained referring to FIG. 12.

The detection value detected by the shock sensor in the HDC 22 is assumed to exceed the range of a threshold ±th by applying vibration or impact on the magnetic disk storage device 1, in a state where the magnetic head 12 is positioned near the zone boundary, during the following control. When receiving a notification that the detection value exceeds the range of the threshold ±th, the HDC 22 lengthens the SG signal of the following servo area, and prepares to allow the PLL to follow easily in the decoder 19. In the example of FIG. 12, an SG signal 211 after the detection of the vibration or the impact is set to be longer than an SG signal 210 before the detection.

When the magnetic head 12 is reciprocated by the vibration or the impact to cross the zone boundary and thus the decoding of the servo areas becomes impossible (illustrated in FIG. 12 with a cross “x”), the MCU 20 controls the VCM drive circuit 15 to apply a VCM current in a direction of putting the magnetic head 12 back to the former zone, to the VCM 14. Thus, the continuous state where the decoding of the servo areas becomes impossible is prevented.

In the example of FIG. 12, when the position of the magnetic head 12 is moved by the vibration or the impact from the zone n to the zone n+1, and thus the decoding of the servo areas becomes impossible, such situation is detected by the MCU 20. When detecting that the decoding of the servo areas becomes impossible, the MCU 20 controls the VCM drive circuit 15 to temporarily change (decrease in the example of FIG. 12) the VCM current. Subsequently, the magnetic head 12 returns to the zone n, and then the decoding of the servo areas is recovered. When detecting that the decoding of the servo areas is recovered, the MCU 20 controls the VCM drive circuit 15 to return the VCM current to the former value. In addition to this, the MCU 20 controls the HDC 22 to reduce the length of the SG signal to be in the former length, as exemplified as an SG signal 212 in FIG. 12.

As described above, a stable control is possible in a medium in which the basic frequency in the servo area varies by zones by controlling so that the decoding of the servo area is possible even during the following control.

The variable amount of the basic frequency in a servo area is expected to be, for example, 10 percent at most on the magnetic disk 10, and zone division is assumed to be performed to displace the basic frequency in ten stages from the ramp load area 30 to the position of the inner stopper 16B, as exemplified in FIG. 13. In this case, the share of the servo area on the magnetic disk 10 can reduce about 5 percent as compared with a share when the basic frequency in the servo area is uniform.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic disk storage device comprising:
a magnetic disk comprising a servo area and a data area corresponding to the servo area on each track, the magnetic disk comprising a surface comprising zones in a radial direction of the magnetic disk corresponding with fundamental frequencies associated with the servo areas in the zones;
a head configured to move in the radial direction and to read a signal from the magnetic disk;
a clock generator configured to generate a clock signal for decoding a signal read from the data area corresponding to the servo area based on a signal read from the servo area;
an estimating module configured to estimate a position of the servo area in the radial direction, where the head reads a signal next, if the head is driven in the radial direction; and
a controller configured to control the clock generator to generate a clock signal of the fundamental frequency corresponding to the servo area where the head reads a signal next before the head reaches the servo area based on the position estimated by the estimating module.

2. The magnetic disk storage device of claim 1, wherein the servo area comprises a preamble area configured to store a signal to be used for generating the clock signal, and
wherein the preamble area is longer than inside the zones at a boundary between the zones.

3. The magnetic disk storage device of claim 1, further comprising a gate signal generator configured to generate a gate signal indicating a period for decoding a signal in the servo area, wherein
a first duration between a first start time of generating a first gate signal for a first servo area and a first start time of decoding a first data in the first servo area is set longer than a second duration between a second start time of generating a second gate signal for a second servo area inside the zones and a second start time of decoding a second data in the second servo area inside the zones when the head crosses the boundary of the zones.

4. The magnetic disk storage device of claim 1, further comprising a storage module configured to store a table indicating correspondence between a position of the boundary of the zones and the fundamental frequency in the servo area, wherein
the controller is configured to read the fundamental frequency corresponding to the position estimated by the estimating module in the table based on the position, and to cause the clock generator to generate the clock signal of the fundamental frequency from the table.

5. A method of controlling a magnetic disk storage device comprising a head configured to move in a radial direction of a magnetic disk to read a signal from the magnetic disk comprising a servo area and a data area corresponding to the servo area on each track and comprising a surface comprising zones in the radial direction corresponding with fundamental frequencies associated with the servo areas in the zones, the method comprising:
a clock generator generating a clock signal for decoding a signal read from the data area corresponding to the servo area based on a signal read from the servo area;
an estimating module estimating a position of the servo area in the radial direction, where the head reads a signal next, if the head is driven in the radial direction; and
a controller controlling the clock generator to generate a clock signal of the fundamental frequency corresponding to the servo area where the head reads a signal next before the head reaches the servo area based on the position estimated by the estimating module.
